(19) United States
(12) Patent Application Publication
(10) Pub. No.: US 2024/0149600 A1
(43) Pub. Date: May 9, 2024

(54) Safety Glazing Identification Systems, Methods, and Apparatus

(71) Applicant: Quality Enclosures Inc., SARASOTA, FL (US)

(72) Inventor: Steven Schwartz, Sarasota, FL (US)

(73) Assignee: Quality Enclosures INC., SARASOTA, FL (US)

(21) Appl. No.: 17/981,509

(22) Filed: Nov. 7, 2022

(51) Int. Cl. B41K 1/38; B41F 17/00; C03B 27/012; C03C 17/00

(52) U.S. Cl. CPC B41K 1/38; B41F 17/00; C03B 27/012; C03C 17/002; C03C 2218/119; C03C 2218/32

(57) ABSTRACT

Systems, methods, and apparatus are disclosed involving safety glazing identification markings, such as for identification of the manufacturer and of the manufacturing details or standards to which the safety glazing was manufactured. Aspects include marking a safety glazing on its edge, marking a safety glazing using a self-inking stamp apparatus, and marking a safety glazing using a fixation-dependent ink that goes from being temporary to being permanent upon being affixed to the safety glazing by using a fixation technique, such as tempering. A system may use a stamp apparatus to apply the marking using a fixation-dependent ink that initially is temporary and removable before fixation; and then may affix the marking by applying a fixation technique to the fixation-dependent ink to affix the ink to the glazing and cause the ink to become permanently affixed to the glazing.

### BACKGROUND OF THE INVENTION

### Field of the Invention

The invention relates to systems, methods, and apparatus involving safety glazing, safety glass, and identification of safety glass details on safety glazing.

### Description of Related Art

The related art includes, for instance, tools, products, and systems, including etches, markings, labels, stickers, inks, and stamps to identify the manufacturer of, and/or to indicate information about, a safety glazing of tempered safety glass, such as an American National Standards Institute (ANSI) rating of the glass. Inasmuch as safety glass may be tempered, conventional prior art technologies have involved adding identification before or after the tempering process.

Tempered glass (also known as toughened glass) is made by heating annealed glass uniformly. The annealed glass is then cooled rapidly by blowing air uniformly onto both front and back surfaces at the same time. This is known as air quenching. Rapid cooling increases the compression forces on and at the surface of the pane (the pane surface typically comprising, for an orthotope, flat-rectangular-prism-shaped pane, in aggregate, the front surface, the back surface, and the edge surfaces, in which the front surface and the back surface are the viewing surfaces through which the pane is intended to be viewed). With increasing the compression forces on and at the surface of the pane, rapid cooling increases the tension forces inside the glass. Tempered glass lites typically are from ⅛″ to ¾″ thick. Tempered glass is about four times stronger than a lite of annealed glass of the same size and thickness. The primary characteristic of the annealed glass affected by tempering is its bending or tensile strength. Tempering increases the tensile strength of glass, which makes tempered glass better able to resist the forces caused by heat, wind, and impact. Tempering does not change: the color, chemical composition, or light transmission characteristics of the annealed glass; its compression strength (the ability of the glass to resist crushing forces); the rate at which the glass conducts and transmits heat; the rate at which the glass expands when heated; or the stiffness of the glass.

Tempered glass offers greater strength against deflection and better wind resistance than heat-strengthened glass. Tempering increases the ability of glass to survive the impact of objects that may strike a building. When tempered glass does break, it shatters into small cubes, reducing the likelihood of serious injury on impact, and qualifying it as a safety glazing material. Tempering increases a lite's edge strength, so it is specified when designers anticipate high thermal stresses. Many large storefront windows are tempered glass, which can be identified by a “bug,” a permanent label in the corner of the window. Tempered glass cannot be cut, drilled, or edged.

In general, according to the International Building Code (IBC) (e.g., 2009, Section 2406.3) safety glazing must be identified, which applies to all glazing, not just tempered glass. Safety glazing also can be, in addition to tempered glass, heat-strengthened glass, plastic, laminated glass, or ceramic fire-resistant glazing. Any glazing that meets the impact loads required by the code for hazardous locations, primarily doors and sidelights, can be considered safety glazing.

The IBC allows for two methods of marking safety glass. The first method is to acid etch, sand blast, ceramic frit, laser etch, or emboss the glass with a permanent manufacturer's designation. This permanent identification is the common marking found on tempered glass in one corner of the glass sheet. The designation identifies the manufacturer and the standard to which the glass is manufactured. The second method allows an applied label including the same information as the manufacturer's designation. The label must comply with the “Label” definition in IBC Section 202.1. The labeling requirement does not include a specific method of marking the glass. However, labels may be less durable (and therefore less permanent) than other methods, labels may be removable or subject to wear, labels may be unsightly or less attractive, and labels may be non-transparent.

Conventional designation methods have had limited capabilities, and such capabilities have suffered from, for example, the limitation that a designation may be obscured or omitted if the portion of the glazing having the designation is cut away from large sheets by the original fabricator, as is common for plastic glazing, creating a challenge of marking the glazing when the product is out of the manufacturer's control. To account for such situations, the IBC includes an exception permitted for glazing materials other than tempered glass in Section 2406.3.1. If accepted by the building official, a certificate, affidavit or other evidence indicating compliance with the code may be permitted in lieu of identification on the glazing. When relying on this exception, be sure the building official agrees to the exception, otherwise a designation or label will be required. However, as indicated above, this exception does not apply to tempered glass in IBC Section 2406.3.1, so conventional approaches for tempered glass are in need of improvement.

In contrast to the prior art, the present invention is unique in its design, in its functionality, and in its intended use of the present invention. The present invention is unlike prior art concepts that have approached identification designations from other angles. The prior art lacks the ease and flexibility of the present invention to accommodate one or multiple identification designations while not impeding the natural beauty of the safety glazing. In contrast, the present solution seeks to enable one or multiple identification designations that are easy to apply, flexible in number and location, and do not impede the natural beauty of the safety glazing.

As described below, embodiments of the present invention include the use of novel features of safety glazing identification, using systems and methods different from those of the prior art systems and methods.

### BRIEF SUMMARY OF THE INVENTION

The invention relates to systems, methods, and apparatus involving safety glazing identification markings, including marking a safety glazing on its edge, or other selected surface; marking a safety glazing using a self-inking stamp apparatus; and marking a safety glazing using a fixation-dependent ink that goes from being temporary to being permanent upon being affixed to the safety glazing by using a fixation technique, such as during tempering. To the extent that permanently affixing the fixation-dependent ink to the glazing may alter the fixation-dependent ink, the permanent printed image formed by affixing the printed fixation-dependent ink comprises a permanent residue, etch, tattoo, affixation, and/or adhesion of the fixation-dependent ink printed on a surface of the glazing used to print the stamped marking information on the glazing.

The safety glazing may comprise tempered glass, heat-strengthened glass, plastic, laminated glass, and/or ceramic fire-resistant glazing. Likewise, the fixation technique and the corresponding fixation-dependent ink are selected and adapted to compatible with and suitable for the selected glazing material or glazing composition. A composite glazing may include, for example, such cases of a glazing composition comprising a laminate of multiple materials to form a multi-layered, multi-material laminated glass.

Application of a selected fixation technique to a correspondingly-selected fixation-dependent ink is adapted to permanently etch, tattoo, affix, adhere, and/or otherwise create a permanent residue of, the information conveyed by the printed ink onto the safety glass. As such, said permanent residue, etch, tattoo, affixation, and/or adhesion may include, cause, and/or incur minor superficial damage to the surface of the safety glass, with said minor damage permanently marking the glazing. However, neither said superficial damage nor said fixation technique selected for the particular safety glass or glazing may undermine the structural integrity of the safety glass glazing as a finished product, or undermine the visual clarity of the glazing overall apart from the portion of the glazing surface on which the ink is printed, etched, and/or tattooed.

In a manufacturing setting according to the present invention, a glazing safety identification system may mark a sheet of glazing (also known as a lite of glazing or a pane of glazing) for identification of the manufacturer and of the manufacturing details or standards to which the safety glazing was manufactured. Moreover, the markings may include any and/or all information required to be marked on a safety glazing by and to meet applicable specific safety codes for the type of safety glazing in the jurisdiction(s) in which the safety glazing is manufactured, sold, and used. Markings also may include optional information such as a website address (uniform resource locator (URL)), or images, such as a logo, of the manufacturer, retailer, or installer. The system may prepare a glazing lite or pane for marking, such as positioning and/or cleaning the glazing to receive a marking; may use a stamp apparatus to apply the marking using a fixation-dependent ink that initially is temporary and removable before fixation; and may affix the marking by applying a fixation technique to the fixation-dependent ink to affix the ink to the glazing and cause the ink to become permanently affixed to the glazing.

In accordance with a first aspect of the invention, a stamp apparatus is disclosed that is adapted for use in marking safety glazing identification, in which the apparatus comprises: a stamp head apparatus adapted to transfer marking information to a glazing and adapted to use a fixation-dependent ink to print the information on the glazing; wherein the fixation-dependent ink is adapted to be affixed to the glazing upon application of a fixation technique to the marking on the glazing. The stamp head apparatus may include the marking information as a raised-print image having raised characters, for instance, forming a relief against a head substrate from which the raised characters project. The stamp head apparatus may be further adapted to stamp, transfer, and/or print the information specifically on a surface of an edge of the glazing, such as of a flat sheet of safety glazing, wherein the apparatus may include an alignment mechanism, such as a fixed frame or one or more pairs of calipers adapted to stabilize, align, position, and/or center the stamp head relative to the edge surface.

In accordance with a second aspect of the invention, a system is disclosed that is adapted for use in marking safety glazing identification, in which the system comprises: a stamp apparatus adapted to transfer a fixation-dependent stamp ink to a glazing to form a configuration of marking information, the fixation-dependent stamp ink, and an ink fixation apparatus adapted to affix the ink and the marking information to the glazing as a result and consequence of application of a fixation technique by the ink fixation apparatus. The system may be further adapted to stamp, transfer, and/or print the information specifically on a surface of an edge of the glazing, such as of a flat sheet of safety glazing, wherein the system may include an alignment mechanism, such as a fixed frame or one or more pairs of calipers adapted to receive, engage, connect, and/or the stamp head apparatus, and to stabilize, align, position, and/or center the stamp head relative to the edge surface.

In accordance with a third aspect of the invention, a method for is disclosed that is adapted for use in marking safety glazing identification, in which the method comprises: preparing a glazing surface to be marked, using a stamp apparatus to stamp fixation-dependent ink in a configuration of marking information on the glazing surface, and affixing the stamp ink using a fixation technique to make the ink permanently affixed to the glazing surface. The method may further comprise using the stamp head apparatus to stamp a surface of an edge of the glazing. The method may additionally comprise using an alignment mechanism, such as a fixed frame or one or more pairs of calipers adapted to receive, engage, connect, and/or the stamp head apparatus, and to stabilize, align, position, and/or center the stamp head relative to the edge surface, for stamping the surface of the edge. In an exemplary embodiment, the safety glazing may include safety glass, and the method further may include tempering the safety glass, wherein tempering is the fixation technique, or wherein tempering is in addition to the fixation technique.

Further aspects of the invention are set forth herein. The details of exemplary embodiments of the invention are set forth in the accompanying drawings and the description below. Other features, objects, and advantages of the invention will be apparent from the description and drawings, and from the claims.

### BRIEF DESCRIPTION OF THE DRAWINGS

By reference to the appended drawings, which illustrate exemplary embodiments of this invention, the detailed description provided below explains in detail various features, advantages, and aspects of this invention. As such, features of this invention can be more clearly understood from the following detailed description considered in conjunction with the following drawings, in which the same reference numerals denote the same, similar, or comparable elements throughout. The exemplary embodiments illustrated in the drawings are not necessarily to scale or to shape and are not to be considered limiting of its scope, for the invention may admit to other equally effective embodiments having differing combinations of features, as set forth in the accompanying claims.

FIG. 1 shows a block diagram of an exemplary embodiment of a system, according to aspects of the invention.

FIG. 2 shows a block diagram of an exemplary embodiment of a method of use of an exemplary system, according to aspects of the invention.

FIG. 3 shows a side perspective view of a conceptual block diagram of an exemplary glazing lite or pane having various exemplary embodiments of stamped information applied by a system and/or a method in accordance with exemplary embodiments of the present invention, according to aspects of the invention.

FIGS. 4A-4D show front perspective views of exemplary embodiments of self-inking stamp apparatus, for use within a system and/or pursuant to a method in accordance with exemplary embodiments of the present invention, according to aspects of the invention.

### DETAILED DESCRIPTION OF THE INVENTION

The invention relates to systems, methods, and apparatus involving safety glazing identification markings, including marking a safety glazing on its edge, marking a safety glazing using a self-inking stamp apparatus, and marking a safety glazing using a fixation-dependent ink that goes from being temporary to being permanent upon being affixed to the safety glazing by using a fixation technique, such as during tempering.

### Exemplary Embodiments of a System

In an exemplary manufacturing setting according to the present invention, a glazing safety identification system may mark a sheet of glazing (also known as a lite of glazing or a pane of glazing) for identification of the manufacturer and of the manufacturing details or standards to which the safety glazing was manufactured. The system may prepare a glazing lite or pane for marking, such as positioning and/or cleaning the glazing to receive a marking; may use a stamp apparatus to apply the marking using a fixation-dependent ink that initially is temporary and removable before fixation; and may affix the marking by applying a fixation technique to the fixation-dependent ink to affix the ink to the glazing and cause the ink to become permanently affixed to the glazing.

In accordance with a first aspect of the invention, a stamp apparatus is disclosed that is adapted for use in marking safety glazing identification, in which the apparatus comprises: a stamp head apparatus adapted to transfer marking information to a glazing and adapted to use a fixation-dependent ink to print the information on the glazing; wherein the fixation-dependent ink is adapted to be affixed to the glazing upon application of a fixation technique to the marking on the glazing.

Some embodiments of the present invention may use a self-inking stamp apparatus to apply the fixation-dependent ink. In some embodiments, the apparatus is a self-inking stamp apparatus that includes the fixation-dependent ink, such as in an integrated ink reservoir. The self-inking stamp apparatus may be adapted to apply ink to a stamp face having the marking information and rotate the stamp face toward the glazing surface to contact the glazing surface and transfer the ink to the glazing surface.

Exemplary embodiments of a self-inking stamp apparatus may include handheld self-inking stamp devices analogous to those used by notary publics to notarize documents, or those used by mailrooms to mark incoming mail as “Received” on a date of receipt. Such self-inking stamp apparatus embodiments may include a stamp that rotates between a resting upward-facing position in contact with a concealed ink reservoir, and a forced downward-facing position in contact with a stamped surface, with a spring-loaded mechanism used to return the stamp to the resting upward-facing position after pressure is removed that forced the stamp to the downward-facing position.

Some embodiments of the present invention may use a fixation-dependent ink that goes from temporary to permanent (“temp-to-perm”) upon being subjected to a fixation technique. Various fixation techniques may include, for instance, application of heat, such as tempering of safety glass; application of a surface chemical deposition (e.g., causing a reactive etch or a layer formation where the chemical is deposited on the ink); application of electromagnetic energy, irradiating the glazing with electromagnetic energy of a particular wavelength, power, and intensity, such as irradiation of the ink with a laser (e.g., causing a reactive etch), a blue light (e.g., causing a resin cure, such as used in dentistry), or an ultraviolet light (e.g., causing an adhesive cure); or a combination thereof, such as application of a surface chemical deposition in conjunction with irradiation or tempering.

A specific example of a fixation-dependent ink affixed using tempering includes a ceramic frit-based ink. A commercially-available ceramic frit-based ink from Ferro is available from Marvel in opaque white or etch (for a frosted look) finish. This product must be applied before sending the glass through a tempering oven, as it is heat activated to make the mark permanent. Marvel sells the frit-based ink in one-pound containers, as well as offering the accompanying medium (or thinner) product in half-pound jars. The medium is used to modify the consistency of the ink based on the tempering plant's environmental conditions. Use of the medium often is recommended, especially to those purchasing their first tempering stamps, but not required by every tempering plant.

Some embodiments of the present invention may use a stamp apparatus to apply the fixation-dependent ink on a front-facing surface of the glazing lite, on a back-facing surface of the glazing lite, on an edge surface of the glazing pane (e.g., bottom edge, top edge, or side edge), or a combination thereof, including having more than one marking application per glazing lite or pane, such as marking a corner of the front surface and multiple markings along a perimeter of the glazing on the edges.

Some embodiments of the present invention may use a first configuration of a marking for the corner (e.g., several shorter lines of text, because more space is available) and a second configuration of a marking for the edge (e.g., one or two longer lines of text, because less space is available, as a glazing edge typically is no wider than ¾ inch, which typically corresponds to a glazing thickness).

In accordance with a second aspect of the invention, a system is disclosed that is adapted for use in marking safety glazing identification, in which the system comprises: a stamp apparatus adapted to transfer a fixation-dependent stamp ink to a glazing to form a configuration of marking information, the fixation-dependent stamp ink, and an ink fixation apparatus adapted to affix the ink and the marking information to the glazing as a result and consequence of application of a fixation technique by the ink fixation apparatus.

In an exemplary embodiment of the system, the stamp apparatus is a self-inking stamp apparatus that applies a fixation-dependent ink to a glazing of safety glass before the safety glass is tempered, and the fixation-dependent ink is affixed to the safety glass glazing when the safety glass is tempered in a tempering apparatus. For example, the fixation-dependent ink may be baked into the safety glass during and as a consequence of tempering the safety glass.

In an exemplary embodiment, the system may include the apparatus of the first aspect of the invention, in which the apparatus is adapted and configured to be used in the system of the second aspect of the invention. The system further may be adapted to apply the fixation-dependent ink to an edge of the glazing in an edge-specific configuration of the marking information, such that the marking is not obscuring any of the glazing transparency through a front surface and a back surface of the glazing. In other words, the marking information may be visible primarily when the pane or lite is viewed from a side of the glazing, or from a perspective angle through the glazing, to see the edge of the glazing. If the marking information is applied with an intention that the marking information should be readable through the glazing from the perspective angle, then the marking information may be applied in a left-to-right mirrored-image configuration, to make any information text appear correctly and readable when viewed from above indirectly through the glazing, whereas such text would appear backwards when viewed directly on the edge. A mirrored-image configuration also may be used if text marked on the back surface of the glazing is intended to the readable when viewed indirectly through the front surface of the glazing.

In accordance with a third aspect of the invention, a method for is disclosed that is adapted for use in marking safety glazing identification, in which the method comprises: preparing a glazing surface to be marked, using a stamp apparatus to stamp fixation-dependent ink in a configuration of marking information on the glazing surface, and affixing the stamp ink using a fixation technique to make the ink permanently affixed to the glazing surface. In an exemplary embodiment, the safety glazing may include safety glass, and the method further may include tempering the safety glass, wherein tempering is the fixation technique, or wherein tempering is in addition to the fixation technique.

### DRAWINGS OF EXEMPLARY EMBODIMENTS OF THE INVENTION

Referring to the Figures, the Figures depict an exemplary manufacturing setting according to the present invention, in which a depicted glazing safety identification system may employ an exemplary method to mark a sheet of glazing (also known as a lite of glazing or a pane of glazing) for identification of the manufacturer and of the manufacturing details or standards to which the safety glazing was manufactured. The depicted system may employ the depicted method to prepare a glazing lite or pane for marking, such as positioning and/or cleaning the glazing to receive a marking; to use a stamp apparatus to apply the marking using a fixation-dependent ink that initially is temporary and removable before fixation; and to affix the marking by applying a fixation technique to the fixation-dependent ink to affix the ink to the glazing and cause the ink to become permanently affixed to the glazing.

The preferred embodiments of the present invention will now be described with reference to the drawings. Identical elements in the various figures are identified with the same reference numerals. Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

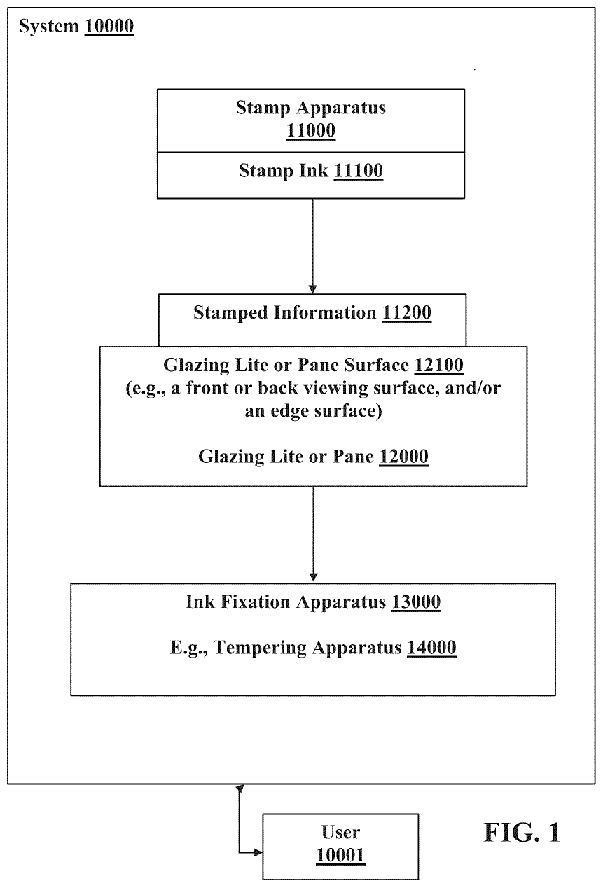

Referring to FIG. 1, FIG. 1 shows a block diagram of an exemplary system 10000 according to aspects of the invention. System 10000 is depicted as including a user 10001 to operate a stamp apparatus 11000 having stamp ink 11100 that may be used to transfer stamped information 11200 to a glazing lite or pane 12000 at a surface 12100 of the glazing lite or pane 12000. After transfer of the stamp ink 11100 in a configuration of stamped information 11200 to the glazing surface 12100, the glazing pane 12000 and the stamped information 11200 may be subjected to an ink fixation apparatus 13000 adapted to apply a fixation technique to permanently affix the stamped ink 11100 to the glazing surface 12100. An exemplary ink fixation apparatus 13000 may include a tempering apparatus 14000 when the safety glazing will comprise tempered glass once manufacturing is completed.

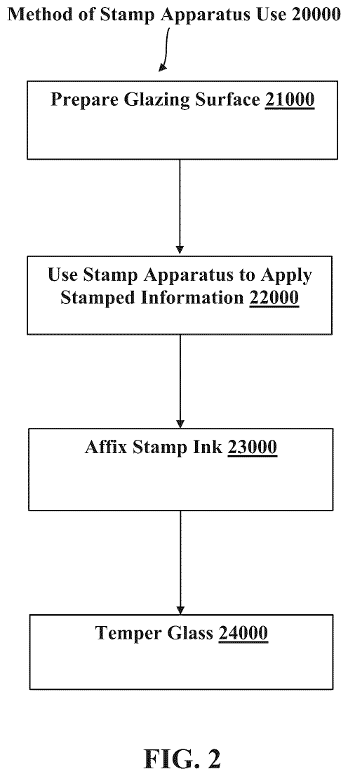

Referring to FIG. 2, FIG. 2 shows a block diagram of an exemplary method 20000 of use of an exemplary system 10000, according to aspects of the invention. The method 20000 is depicted as beginning with step 21000 of preparing the glazing surface 12100 to receive the stamp ink 11100 in the configuration of stamped information 11200. Step 22000 includes using the stamp apparatus 11000 to apply the stamp ink 11100 in the configuration of the stamped information 11200. Step 23000 includes permanently affixing the stamp ink 11100 in the configuration as the stamped information 11200 using a fixation technique. The fixation technique used will depend on the choice of glazing 12000 (e.g., plastic versus glass) and the choice of stamp ink 11100. If the glazing 12000 will be tempered glass once manufacturing is completed, the method 20000 may include step 24000 that includes tempering the glass glazing 12000. Step 23000 of affixing the stamped ink 11100 may be part of step 24000 of tempering the glass when the safety glazing 12000 will be safety tempered glass once manufactured.

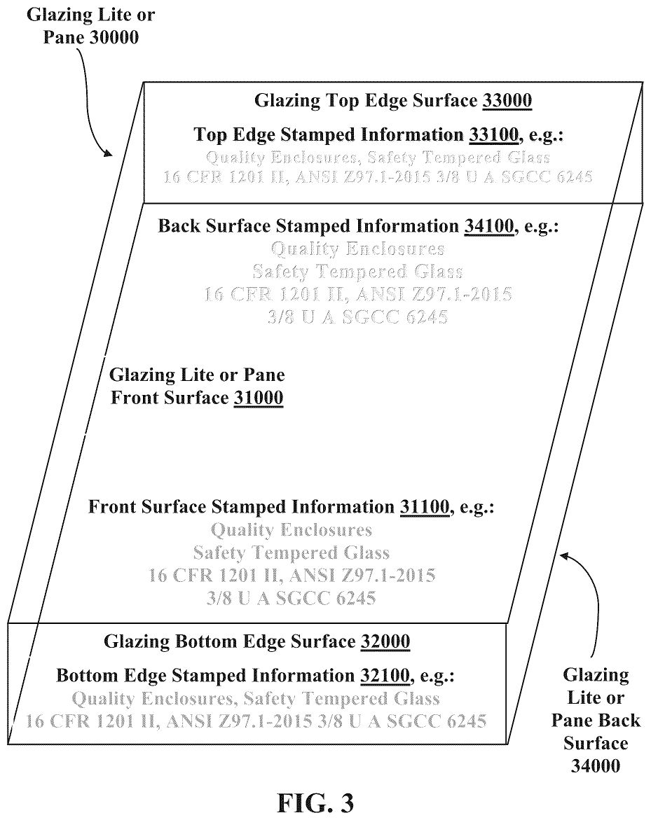

Referring to FIG. 3, FIG. 3 shows a side perspective view of a conceptual block diagram of an exemplary glazing lite or pane 30000 having various exemplary embodiments of stamped information 31100, 32100, 33100, 34100 applied by a system 10000 and/or a method 20000 in accordance with exemplary embodiments of the present invention, according to aspects of the invention. The glazing 30000 is depicted as having a front surface 31000 having front surface stamped information 31100, a bottom edge surface 32000 having bottom edge stamped information 32100, a top edge surface 33000 having top edge stamped information 33100, and a back surface 34000 having back surface stamped information 34100. The front surface 31000 is opposite the back surface 34000, and the bottom edge surface 32000 is opposite the top edge surface 33000.

The front surface stamped information 31100 and the back surface stamped information 34100 may comprise a first configuration of stamped information that is depicted as including four shorter lines of text. The bottom edge stamped information 32100 and the top edge stamped information 33100 may comprise a second configuration of stamped information that is depicted as including two longer lines of text. The first configuration and the second configuration may include the same information, just arranged differently to accommodate the dimensions of the available surface. Marking the stamped information on an edge 32000, 33000 of the glazing has the advantage over marking the front surface 31000 or back surface 34000, in that the marking is minimally visible on, and does not detract from the beauty of, the finished safety glazing. Moreover, including markings at multiple places along the edges may account for possible future subdivision of the glazing post-marking, without the need for using a label or obtaining a paper certification of compliance with safety codes to accompany subdivided glazing panes.

If the glazing lite or pane 30000 will be tempered glass once manufactured, the pane 30000 may not be cut once tempered, so if the glazing is to be cut into smaller pieces, the cutting must occur before tempering, and multiple markings may be added before or after the cutting. If the fixation technique is tempering, the stamped information must be applied before tempering. If the pane 30000 will be a safety glazing other than tempered glass, such as a plastic glazing, and the safety glazing might be cut after manufactured, the markings may be added in a distributed fashion before the glazing 30000 is cut.

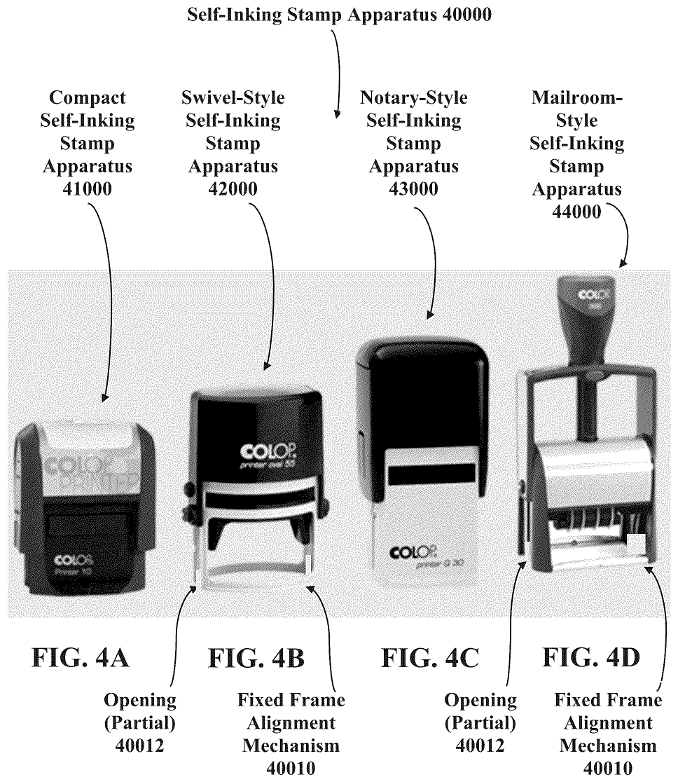

Referring to FIG. 4A to FIG. 4D, FIGS. 4A-4D show front perspective views of exemplary embodiments of a self-inking stamp apparatus 40000, for use within a system 10000 and/or pursuant to a method 20000 in accordance with exemplary embodiments of the present invention, according to aspects of the invention. FIG. 4A depicts a compact self-inking stamp apparatus 41000, which may include a concealed ink reservoir (not visible) having ink (not visible) flowing to a static stamp head (not visible) that travels down and up in the stamping mechanism without rotating. FIG. 4B depicts a swivel-style self-inking stamp apparatus 42000, which may include a concealed ink reservoir (not visible) having ink (not visible) contacting a raised-print stamp head (not visible) that rotates when it travels down and up in the stamping mechanism. FIG. 4C depicts a notary-style self-inking stamp apparatus 43000, which may include a concealed ink reservoir (not visible) having ink (not visible) contacting a raised-print stamp head (not visible) that rotates when it travels down and up in the stamping mechanism. FIG. 4D depicts a mailroom-style self-inking stamp apparatus 44000, which may include a concealed ink reservoir (not visible) having ink (not visible) contacting an adjustable stamp head (not visible) that rotates when it travels down and up in the stamping mechanism. The style of self-inking stamp apparatus 40000 preferred for a given embodiment of system 10000 may depend on various factors, such the glazing types, glazing volumes, and different details to be stamped in the stamped information. The stamp head apparatus 40000 may be further adapted to stamp, transfer, and/or print the information specifically on a surface of an edge of the glazing, such as of a flat sheet of safety glazing, wherein the apparatus 40000 may include an alignment mechanism 40010, such as a fixed frame 40010, or one or more pairs of calipers adapted to stabilize, align, position, and/or center the stamp head relative to the edge surface. As depicted in FIG. 4B and FIG. 4D, the narrow sides of the fixed frames 40010 include openings 40012 (full or partial) that are open to allow insertion of the edge for alignment of the edge relative to the stamping device, and then stamping of the edge by the stamping device.

The foregoing description discloses exemplary embodiments of the invention. While the invention herein disclosed has been described by means of specific embodiments and applications thereof, numerous modifications and variations could be made thereto by those skilled in the art without departing from the scope of the invention set forth in the claims. Modifications of the above disclosed apparatus and methods that fall within the scope of the claimed invention will be readily apparent to those of ordinary skill in the art. Accordingly, other embodiments may fall within the spirit and scope of the claimed invention, as defined by the claims that follow hereafter.

In the description above, numerous specific details are set forth in order to provide a more thorough understanding of embodiments of the invention. It will be apparent, however, to an artisan of ordinary skill that the invention may be practiced without incorporating all aspects of the specific details described herein. Not all possible embodiments of the invention are set forth verbatim herein. A multitude of combinations of aspects of the invention may be formed to create varying embodiments that fall within the scope of the claims hereafter. In addition, specific details well known to those of ordinary skill in the art have not been described in detail so as not to obscure the invention. Readers should note that although examples of the invention are set forth herein, the claims, and the full scope of any equivalents, are what define the metes and bounds of the invention protection. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A stamp apparatus adapted for use in marking a glazing with safety glazing identification, the apparatus comprising:
a stamp head apparatus including a raised-print image corresponding to stamped marking information comprising the safety glazing identification;
wherein the stamp head apparatus is adapted to transfer the stamped marking information to the glazing;
wherein the stamp head apparatus is adapted to use a fixation-dependent ink to print the stamped marking information on the glazing; and
wherein the fixation-dependent ink is adapted to be affixed permanently to the glazing upon application of a fixation technique to the stamped marking information on the glazing.

2. The apparatus of claim 1, further comprising:
an ink reservoir adapted to contain the fixation-dependent ink;
wherein the stamp head apparatus is adapted to contact the ink reservoir.

3. The apparatus of claim 2, further comprising:
the fixation-dependent ink.

4. The apparatus of claim 2, wherein the stamp apparatus comprises a self-inking stamp apparatus, and the stamp head apparatus includes a travel mechanism to force the raised-print image to contact a glazing surface upon applying pressure to the travel mechanism.

5. The apparatus of claim 1, wherein the fixation technique comprises tempering, and the fixation-dependent ink is adapted to be permanently affixed to the glazing upon tempering the glazing.

6. The apparatus of claim 1, wherein the fixation technique comprises electromagnetic irradiation, and the fixation-dependent ink is adapted to be permanently affixed to the glazing upon irradiating the glazing with electromagnetic energy of a particular wavelength, power, and intensity.

7. The apparatus of claim 1, wherein the fixation technique comprises surface chemical deposition, and the fixation-dependent ink is adapted to be permanently affixed to the glazing upon deposition of a chemical to the surface having the stamped information.

8. The apparatus of claim 1, wherein the stamp head apparatus further is adapted to transfer the fixation-dependent ink to, and to print the stamped marking information on, an edge surface of an edge of the glazing.

9. A safety glazing marked with safety glazing identification, the safety glazing comprising:
a printed image corresponding to stamped marking information comprising the safety glazing identification;
wherein the printed image comprises a permanent residue of a fixation-dependent ink printed on a surface of the glazing to print the stamped marking information on the glazing; and
wherein the fixation-dependent ink was affixed to the glazing upon application of a fixation technique to the fixation-dependent ink printed on the glazing.

10. The safety glazing of claim 9, wherein the fixation-dependent ink has been printed on an edge surface of an edge of the glazing.

11. The safety glazing of claim 9, wherein the fixation technique comprises tempering, and the fixation-dependent ink has been permanently affixed to the glazing upon tempering the glazing.

12. The safety glazing of claim 9, wherein the fixation technique comprises electromagnetic irradiation, and the fixation-dependent ink has been permanently affixed to the glazing upon irradiating the glazing with electromagnetic energy of a particular wavelength, power, and intensity.

13. The safety glazing of claim 9, wherein the fixation technique comprises surface chemical deposition, and the fixation-dependent ink has been permanently affixed to the glazing upon deposition of a chemical to the surface having the stamped information.

14. A system adapted for use in marking a glazing with safety glazing identification, the system comprising:
a stamp apparatus adapted for use in marking safety glazing identification, the apparatus comprising:
a stamp head apparatus including a raised-print image corresponding to stamped marking information comprising the safety glazing identification;
wherein the stamp head apparatus is adapted to transfer the stamped marking information to a glazing;
wherein the stamp head apparatus is adapted to use a fixation-dependent ink to print the stamped marking information on the glazing; and
wherein the fixation-dependent ink is adapted to be affixed permanently to the glazing upon application of a fixation technique to the stamped marking information on the glazing;
an ink fixation apparatus adapted to apply the fixation technique to the stamped marking information comprising the safety glazing identification;

15. The system of claim 14, wherein the glazing comprises glass to be tempered, the fixation technique comprises tempering the glass, and the ink fixation apparatus comprises a tempering apparatus.

16. The system of claim 14, the system further comprising the fixation-dependent ink, and,
wherein the stamp apparatus further comprises:
an ink reservoir adapted to contain the fixation-dependent ink;
wherein the stamp head apparatus is adapted to contact the ink reservoir.

17. A method adapted for use in marking a glazing with safety glazing identification, the method comprising:
using a stamp apparatus to mark the safety glazing identification, the stamp apparatus being adapted for use in marking safety glazing identification, and the apparatus comprising:
a stamp head apparatus including a raised-print image corresponding to stamped marking information comprising the safety glazing identification;
wherein the stamp head apparatus is adapted to transfer the stamped marking information to a glazing;
wherein the stamp head apparatus is adapted to use a fixation-dependent ink to print the stamped marking information on the glazing; and
wherein the fixation-dependent ink is adapted to be affixed permanently to the glazing upon application of a fixation technique to the stamped marking information on the glazing;
printing the stamped marking information on the glazing using the fixation-dependent ink and the stamp apparatus;
using an ink fixation apparatus adapted to apply the fixation technique to the stamped marking information comprising the safety glazing identification; and
applying the fixation technique to the printed fixation-dependent ink depicting the stamped marking information.

18. The method of claim 17, the method further comprising:
printing the stamped marking information on an edge surface of an edge of the glazing using the fixation-dependent ink and the stamp apparatus.

19. The method of claim 17, wherein the glazing comprises glass to be tempered, the fixation technique comprises tempering the glass, and the ink fixation apparatus comprises a tempering apparatus.

20. The method of claim 17, the method further comprising:
tempering the glazing.
